(19) United States
(12) Patent Application Publication
(10) Pub. No.: US 2007/0139608 A1
(43) Pub. Date: Jun. 21, 2007

(54) Glasses structure

(76) Inventor: Chih-Ming Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/312,751

(22) Filed: Dec. 21, 2005

(51) Int. Cl. G02C 5/00

(52) U.S. Cl. 351/41

(57) ABSTRACT

A glasses structure comprises a glasses frame and a pair of earpieces. The present invention is characterized in that a coating layer is coated around the glasses frame of the glasses structure, wherein the coating layer is made of a soft-type material and has a thickness ranged from 0.4 mm to 2 mm. In addition, 75 percent or more of glasses frame is covered with the coating layer. As a result, the glasses structure is provided with the buffer function for isolation and protection so as to prevent the collision or the impact of external force from damaging the glasses structure. Moreover, the glasses structure is provided with hazy, layered appearance.

### FIELD OF THE INVENTION

The present invention relates to an improved glasses structure, and more particularly to a glasses structure having a coated glasses frame.

### BACKGROUND OF THE INVENTION

Owing to inborn constitution or acquired bad posture from reading, watching computer, using Internet, or watching television for a long period of time, the modern people commonly suffer from nearsightedness or farsightedness. As a result, a pair of auxiliary glasses is necessary for rectification.

Besides, a glasses frame of the general glasses is made of hard-type material. As a result, the glasses are damaged easily by the collision or the impact of external force in the absence of buffer function.

Moreover, most general glasses are made of metal materials so they are too heavy for the user's nose bridge. As a result, the user is suffered from pressing marks, aches, and discomfort after long-term wear.

### SUMMARY OF THE INVENTION

It is a major object of the present invention to provide a glasses structure, which comprises a glasses frame and a pair of earpieces. The present invention is characterized in that a coating layer is coated around the glasses frame of the glasses structure, wherein the coating layer is made of a soft-type material and has a thickness ranged from 0.4 mm to 2 mm. In addition, 75 percent or more of glasses frame is covered with the coating layer. As a result, the glasses structure is provided with the buffer function for isolation and protection so as to prevent the collision or the impact of external force from damaging the glasses structure.

It is another object of the present invention to provide a glasses structure, which comprises a glasses frame and a pair of earpieces. The present invention is characterized in that a coating layer is coated around the glasses frame of the glasses structure, wherein the coating layer is made of a soft-type material and has a thickness ranged from 0.4 mm to 2 mm. In addition, 75 percent or more of glasses frame is covered with the coating layer. By using the soft-type material, the glasses structure is lighter in weight so as to prevent the user's nose bridge from suffering too much burden after long-term wear.

It is still another object of the present invention to provide a glasses structure, which comprises a glasses frame and a pair of earpieces. The present invention is characterized in that a coating layer is coated around the glasses frame of the glasses structure, wherein the coating layer is made of a soft-type material and has a thickness ranged from 0.4 mm to 2 mm. In addition, 75 percent or more of glasses frame is covered with the coating layer. Moreover, the coating layer is made of transparent (lucid) material so as to provide the glasses structure with hazy, layered appearance.

### BRIEF DESCRIPTION OF THE DRAWINGS

FIG. 1 is a three-dimensional view showing a first preferred embodiment of the present invention.

FIG. 2 is a cross-sectional plan view showing the first preferred embodiment of the present invention.

FIG. 3 is a three-dimensional view showing a second preferred embodiment of the present invention.

FIG. 4 is a three-dimensional view showing a third preferred embodiment of the present invention.

### DETAILED DESCRIPTION OF THE PREFERRED EMBODIMENT

The description taken with the drawings make the structures, features, and embodiments of the present invention apparent to those skilled in the art how the present invention may be embodied in practice.

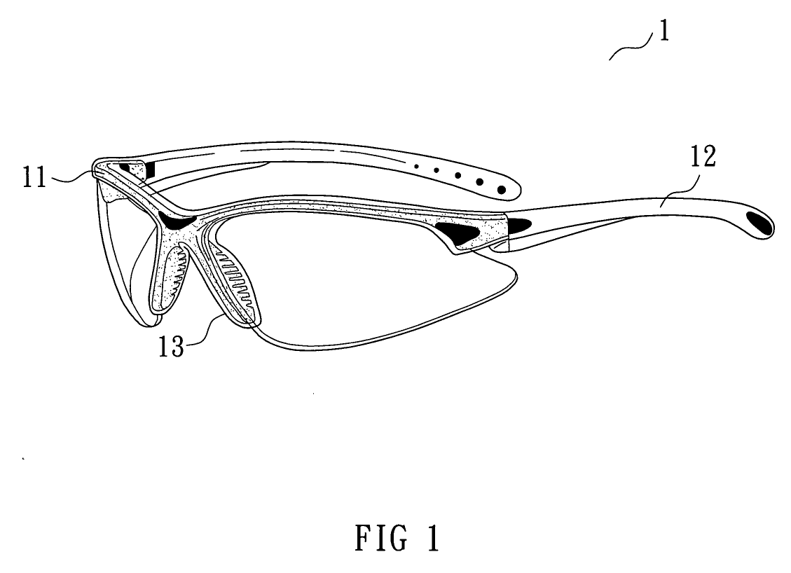

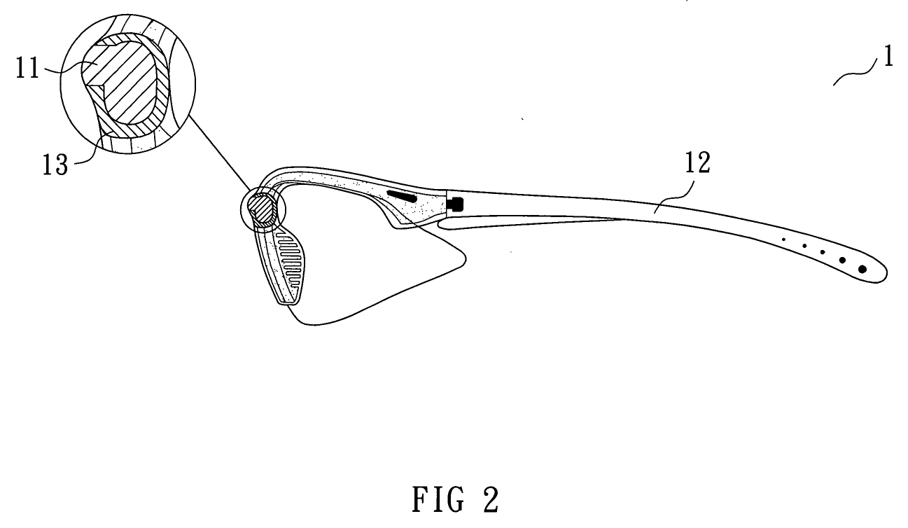

Referring to FIG. 1 and FIG. 2, the present invention relates to an improved glasses structure 1, which comprises a glasses frame 11 and a pair of earpieces 12.

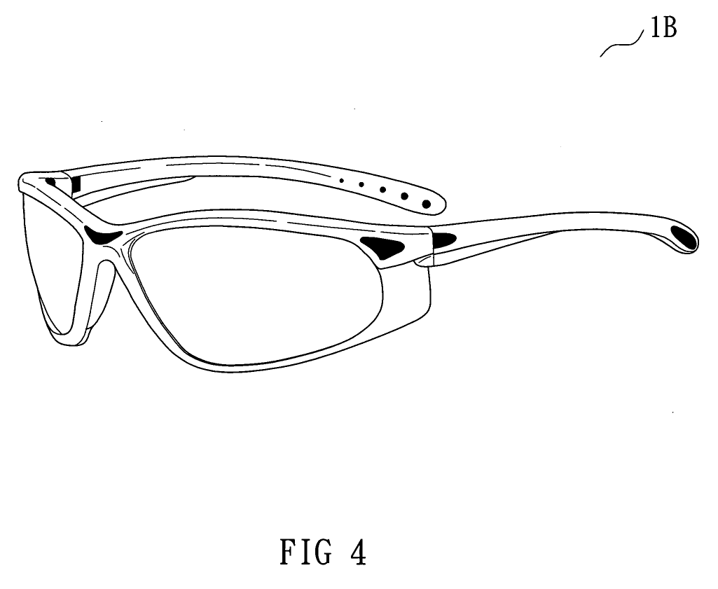

The glasses frame 11 is a half-rim frame or a full-rim frame 1B (shown in FIG. 4). Moreover, according to the definition of the present invention, the glasses frame 11 may merely be a light traverse bar located on the top of the glasses structure.

The earpieces 12 are connected to or extended from both sides of the glasses frame 11.

The present invention is characterized in that a coating layer 13 is coated around the glasses frame 11 of the glasses structure 1, wherein the coating layer 13 is made of a soft-type material and has a thickness ranged from 0.4 mm to 2 mm. In addition, 75 percent or more of glasses frame 11 is covered with the coating layer 13.

According to the definition of the present invention, the thickness of the coating layer 13 is ranged from 0.4 mm to 2 mm and 75 percent or more of glasses frame 11 is coated with the coating layer 13, whereby the user who wears the glasses structure is prevented from heavy weight caused by the excessively thick coating layer 13, and the glasses structure can keep its light, thin, and handy design. Moreover, the glasses structure of the present invention must take the buffer function into consideration simultaneously so the coating layer 13 that is excessively thin and that has insufficient coated area is not applicable. As a result, the technique of the present invention is characterized in that the thickness of the coating layer 13 is ranged from 0.4 mm to 2 mm and that 75 percent or more of glasses frame 11 is coated with the coating layer 13 according to experiment results.

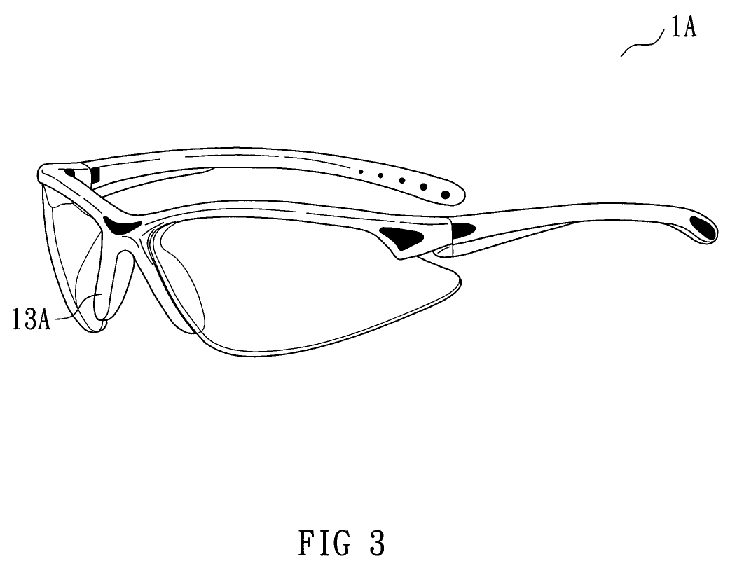

Besides, as shown in FIG, 1, the coating layer 13 is transparent in accordance with the preferred embodiment of the present invention, thereby providing a beautiful appearance by using the hazy effect of coating layer 13 and the design of the glasses structure 1. Moreover, referring further to FIG. 3, the coating layer 13A may be made of different material in accordance with another preferred embodiment of the present invention. For example, the coating layer 13A of the glasses structure 1A is an opaque colored layer so as to provide another beautiful appearance.

In summary, the anticipated efficacy that can be achieved by the present invention consists in that:

1. The coating layer is coated around the glasses frame of the glasses structure of the present invention, wherein the coating layer is made of a soft-type material and has a proper thickness for providing the buffer function, thereby preventing the collision or the impact of external force from damaging the glasses structure;

2. The coating layer is coated around the glasses frame of the glasses structure of the present invention, wherein the coating layer is made of a soft-type material and has a proper thickness for providing the glasses structure with a lighter weight so as to prevent the user's nose bridge from suffering too much burden after long-term wear;

3. The coating layer is coated around the glasses frame of the glasses structure of the present invention, wherein the coating layer is made of a soft-type material and has a proper thickness such that the glasses structure can keep its light, thin, and handy design; and

4. The coating layer of the present invention may be transparent or opaque so as to provide the glasses structure with the hazy, layered appearance or the colored appearance.

On the basis of the description mentioned above, the present invention indeed satisfies requirements for patentability since it provides practicability and has never been published as a printed book or used publicly. Therefore, it is submitted for a patent.

With the invention thus explained, it is apparent that various modifications and variations can be made without departing from the scope of the invention. It is therefore intended that the invention be limited only as indicated in the appended claims.

What the invention claimed is:

1. A glasses structure comprising:
a glasses frame and a pair of earpieces,
wherein a coating layer is coated around the glasses frame of the glasses structure,
wherein the coating layer is made of a soft-type material and has a thickness ranged from 0.4 mm to 2 mm, and
wherein 75 percent or more of glasses frame is covered with the coating layer.

2. The glasses structure of claim 1, wherein the glasses frame is a full-rim frame.

3. The glasses structure of claim 1, wherein the glasses frame is a half-rim frame.

4. The glasses structure of claim 1, wherein the coating layer is transparent.

5. The glasses structure of claim 1, wherein the coating layer is opaque.

6. The glasses structure of claim 1, wherein the coating layer is colored and slightly transparent.
